(19) United States
(12) Patent Application Publication
(10) Pub. No.: US 2021/0206112 A1
(43) Pub. Date: Jul. 8, 2021

(54) SERVICE FOR THREE-DIMENSIONAL PRINTING

(71) Applicant: HEWLETT-PACKARD DEVELOPMENT COMPANY, L.P., Spring, TX (US)

(72) Inventors: Jeremy BARRIBEAU, Vancouver, WA (US); Adam L. HORNSTEIN, San Diego, CA (US)

(73) Assignee: HEWLETT-PACKARD DEVELOPMENT COMPANY, L.P., Houston, TX (US)

(21) Appl. No.: 16/075,601

(22) PCT Filed: Apr. 20, 2017
(86) PCT No.: PCT/US2017/028630

§ 371 Date: Aug. 4, 2018

(51) Int. Cl. B29C 64/393; B29C 64/165; H04N 1/34; B29C 64/255

(52) U.S. Cl. CPC B29C 64/393; B29C 64/165; B33Y 50/02; B29C 64/255; H04N 1/34

(57) ABSTRACT

An example device includes a user interface, a third party identification portion, a third-party interface and a three-dimensional (3D) print data file handling portion. The user interface is to receive a service request from a user device, the service request including a 3D print data file and identification of a service associated with the 3D print data file. The third party identification portion is to identify a selected third party from a set of third parties, the selected third party having capabilities associated with the service. The third-party interface is to receive the service from the selected third party. The 3D print data file handling portion is to replace the 3D print data file with a revised 3D print data file, the revised 3D print data file being the 3D print data file with the service performed.

### BACKGROUND

Three-dimensional (3D) printing is becoming ubiquitous in a variety of environments. For example, many manufacturing arrangements regularly utilize 3D printing to manufacture or facilitate the manufacturing of various components. Further, 3D printers are becoming accessible to smaller entities and individuals.

### BRIEF DESCRIPTION OF THE DRAWINGS

For a more complete understanding of various examples, reference is now made to the following description taken in connection with the accompanying drawings in which:

FIG. 1 illustrates an example device which may provide a platform for advanced services;

FIG. 2 illustrates an example system for providing 3D printing services to users;

FIG. 3 illustrates an example flow in a process for providing 3D printing services;

FIG. 4 is a flow chart illustrating an example method for providing 3D printing services; and

FIG. 5 illustrates a block diagram of an example system with a computer-readable storage medium including instructions executable by a processor for providing 3D printing services.

### DETAILED DESCRIPTION

Various examples provide for systems, platforms or methods for providing enhanced services for three-dimensional (3D) printing. A user desiring an enhanced service for a three-dimensional printing task may communicate with an enhanced services platform to request a desired service. In various examples, the user transmits a request to the platform with identification of the desired service, as well as the 3D print data file for which the service is desired. The platform can interface with various third-party service providers, such as software providers. The platform may identify a third-party service provider with capabilities to perform the service. The capabilities may include performing the service or providing software capable of performing the service. In one example, the platform transmits the 3D print data file to the third-party service provider for performing the service. The platform may receive a revised 3D print data file from the third-party service provider. In another example, the platform may perform the service using software from the third-party service provider. The platform can then transmit the revised 3D print data file to the user for printing on a 3D printer.

As described above, 3D printers are becoming accessible to smaller entities and even individual users. The lower-cost, 3D printers available to such smaller entities may include basic software or driver which may lack advanced functionality. Various examples described herein provide such smaller entities, as well as other users, with access to advanced functions for 3D printing. Further, various examples provide a marketplace for users desiring such advanced functions to access third-party vendors which may provide services related to the desired advanced functions.

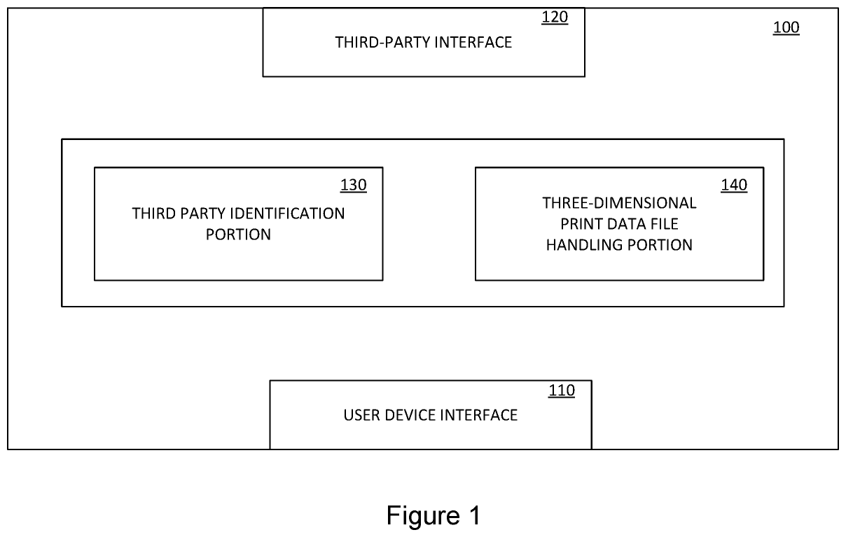

Referring now to the figures, FIG. 1 illustrates an example device 100 which may provide a platform for advanced services. In various examples, the example device 100 may be a server available on a public network, such as the Internet, or able to otherwise communicate with other electronic devices. In this regard, the example device 100 of FIG. 1 is provided with a user device interface 110 for communicating with one or more user devices. The user device interface 110 may include, for example, hardware, software, firmware or a combination thereof to allow a user device (not shown in FIG. 1) to access one or more features or services provided on the example device 100. For example, the user interface 110 may include an application program interface (API) to allow communication with an application on a user device.

Similarly, the example device 100 includes a third party interface 120 for allowing the example device 100 to communicate with one or more third parties. As described below, the third parties may be, for example, vendors that can provide services related to 3D printing. In one example, one of the third parties may be the manufacturer of the 3D printer used by the user device. The third party interface 120 may allow each third party (not shown in FIG. 1) to access one or more features or services provided on the example device 100. For example, the third party interface 120 may include an application program interface (API) to allow communication with an application on a third party device.

The user interface 110 of the example device 100 of FIG. 1 allows the example device 100 to receive a service request from a user device. The service request may include a 3D print data file. In various examples, the 3D print data file may include information related to the 3D printing of an object to allow a 3D printer to produce the object. The 3D print data file may be in any of a variety of formats readable by a 3D printer.

The request from the user device may further include identification of a service associated with the 3D print data file. For example, the request may include an indication that the objects included in the 3D print data file are to be more efficiently packed in a limited space, revised to minimize the amount of consumable or the amount of time used to print, or modified with another advanced feature. Other advanced features may include, but not limited to, 3D object nesting of multiple objects in the 3D print data file, protective cage generation of an object, splitting of an oversized object or forming of a powder escape hole in the object, for example. Other advanced features, or services, are possible and are contemplated within the scope of the present disclosure.

The example device 100 of FIG. 1 further includes a third party identification portion 130. The third party identification portion 130 may select one third-party vendor from a set of third-party vendors that may offer services related to 3D printing. In this regard, the third party identification portion 130 may include a database of available third-party vendors, for example, that are registered or approved by the example device 100. In various examples, the third party identification portion 130 may include logic to identify one or more third-party vendors with capabilities associated with the service requested by the user device. In this regard, the third-party vendors may be identified for either the ability to perform the requested service or offering software to perform the service. In one example, when two or more third party vendors are identified as capable of providing the service, the third party identification portion 130 may select a third party vendor to minimize cost of the service.

The example device 100 of FIG. 1 is provided with a 3D print data file handling portion 140. In various examples, the 3D print data file handling portion 140 is provided to manage the 3D print data file received from the user device. In this regard, the 3D print data file handling portion 140 may replace the 3D print data file received from the user device with a revised 3D print data file. The revised 3D print data file includes information in the 3D print data file received from the user device modified in accordance with the requested service. In one example, the 3D print data file handling portion 140 replaces the 3D print data file with a revised 3D print data file received from a third-party vendor. In this regard, the example user device 100 may transmit the 3D print data file to the selected third party and receiving the revised 3D print data file from the third party. In another example, the 3D print data file handling portion 140 may replace the 3D print data file with a revised 3D print data file by downloading software associated with the service from the third party. The 3D print data file handling portion 140 may then use the downloaded software to perform the service on the 3D print data file to generate the revised 3D print data file.

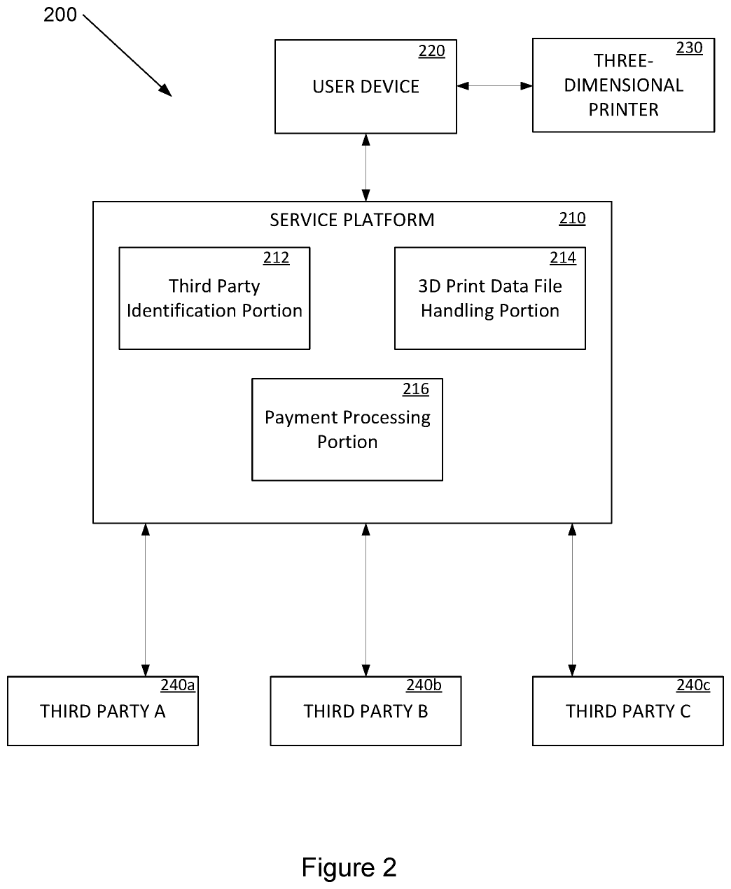

Referring now to FIG. 2, an example system 200 for providing 3D printing services to user devices is illustrated. The example system 200 includes a service platform 210 that may be similar to the example device 100 described above with reference to FIG. 1. In this regard, the service platform 210 includes a third party identification portion 212, a 3D print data file handling portion 214 and a payment processing portion 216. The third party identification portion 212 of the service platform 210 may be similar to the third party identification portion 130 of the example device 100 described above with reference to FIG. 1. Similarly, the 3D print data file handling portion 214 of the service platform 210 may be similar to the 3D print data file handling portion 140 of the example device 100 described above with reference to FIG. 1.

The service platform 210 of the example system 200 of FIG. 2 further includes a payment processing portion 216. The payment processing portion 216 may facilitate payment for the 3D printing services, an example of which is described below.

The example system 200 of FIG. 2 includes a user device 220 communicatively coupled to the service platform 210. In various examples, the user device 220 may communicate with the service platform 210 through a network, such as the Internet. In this regard, in some examples, the service platform 210 may be implemented as a cloud-based service. Further, while FIG. 2 illustrates a single user device 220 coupled to the service platform 210, any number of user devices may access the service platform 210.

In one example, the user device 220 communicates with the service platform 210 through an application running on the user device 220. In this regard, the application on the user device 220 may send and receive information to the service platform 210 through an API. As described above with reference to FIG. 1, the user device 220 may send a service request to the service platform 210, the service request including a 3D print data file and identification of a service to be performed on the 3D print data file.

The user device 220 of the example system 200 is coupled to a 3D printer 230. The 3d printer may use any of a variety of 3D printing technologies. Examples of such 3D-printing technologies include, without limitation, stereolithography (SLA), fused deposition modeling (FDM), selective laser sintering (SLS), and 3D binder jetting.

The service platform 210 of the example system 200 is coupled to at least one third-party service provider 240a-c. In the example system 200 of FIG. 2, the service platform 210 is coupled to three third-party service provider 240a-c, but any number of third-party service provider 240a-c is possible and is contemplated within the scope of the present disclosure. As described above, each third-party service provider may be capable of providing one or more advanced services.

In various examples, upon receiving the request from the user device 220, the service platform 210 may coordinate provision of the requested service, resulting in a revised 3D print data file. In one example, the service platform 210 transmits the 3D print data file to the selected third-party service provider 240a-c. The third-party service provider 240a-c may then perform the service on the 3D print data file and return a revised 3D print data file to the service platform 210. The service platform 210 may then send the revised 3D print data file to the user device 220.

The service platform 210 may also process payment for the service either prior to, in parallel with or subsequent to the handling of the 3D print data file by the 3D print data file handling portion 214. In this regard, based on the selected service provider 240a-c, the payment processing portion 216 may calculate a payment amount for the requested service. The payment processing portion 216 may take payment from the user device 220 (e.g., credit card or charge a user account) and forward at least a part of the payment amount to the selected third party service provider 240a-c.

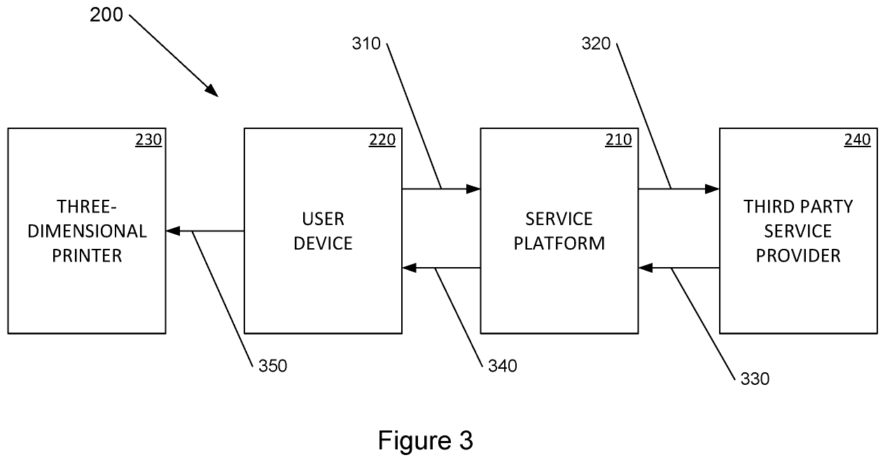

Referring now to FIG. 3, an example flow in a process for providing 3D printing services in the example system 200 of FIG. 2 is illustrated. In the illustrated example of FIG. 3, the user device 220 may first send a request to the service platform 210 (line 310). As noted above, the request includes a 3D print data file and an identification of the service requested. The service platform 210 may then send the 3D print data file to a selected third party service provider 240 (line 320). The selected third party service provider 240 may perform the service on the 3D print data file and send a revised 3D print data file to the service platform 210 (line 330). The service platform 210 then forwards the revised 3D print data file to the user device 220 (line 340). The revised 3D print data file may then be sent from the user device 220 to the 3D printer 230 coupled to the user device 220 (line 350) for production of one or more products described in the revised 3D print data file.

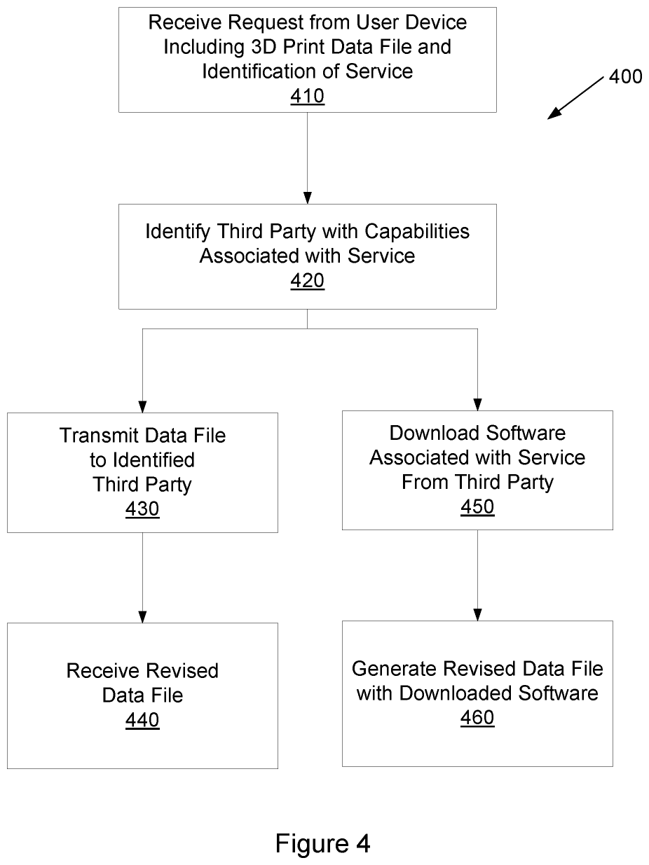

Referring now to FIG. 4, a flow chart illustrates an example method for providing 3D printing services. The example method 400 illustrated in FIG. 4 may be implemented in any of a variety of devices. In one example, the example method 400 is implemented in the service platform 210 of FIGS. 2 and 3. In the example method 400, a request is received from a user device (block 410). The request includes a 3D print data file and identification of a service associated with the 3D print data file. For example, as described above with reference to FIG. 2, the service platform 210 may receive a service request from the user device 220, the service request including a 3D print data file and identification of a service to be performed on the 3D print data file.

Referring again to FIG. 4, the example method 400 further includes identifying a third party with capabilities associated with the requested service (block 420). For example, the service platform 210 may identify one third party service provider from the set of third party service providers 240a-c that has the capabilities to satisfy the requested service. In this regard, the selected third party service provider may either be able to perform the service itself or offer tools (e.g., software) that allow the requested service to be performed by the service platform 210.

In various examples of the method 400 of FIG. 4, the 3D print data file may be replaced with a revised 3D print data file that includes information in the 3D print data file received at block 410 modified in accordance with the requested service. In one example, the 3D print data file is transmitted to the selected third party (block 430), and a revised 3D print data file is received from the third party (block 440). In another example, software associated with the requested service may be downloaded from the third party (block 450), and a revised 3D print data file may be generated with the downloaded software (block 460). In this regard, the software may perform the desired service on the 3D print data file to generate the revised 3D print data file.

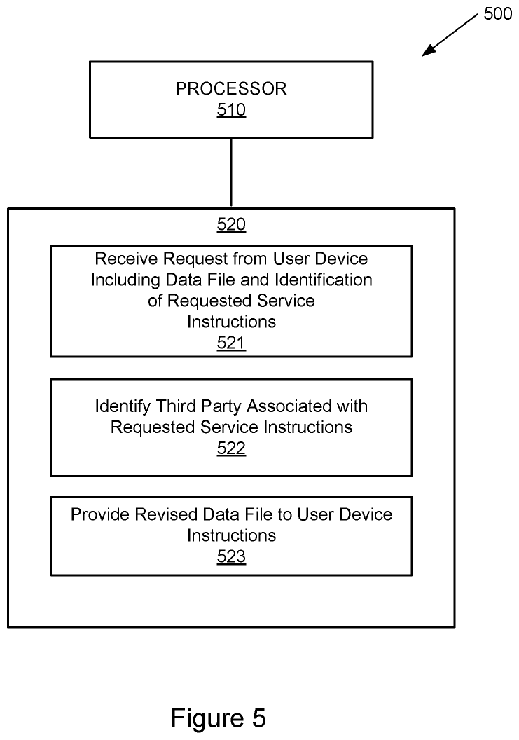

Referring now to FIG. 5, a block diagram of an example system is illustrated with a non-transitory computer-readable storage medium including instructions executable by a processor for providing a service for 3D printing. The system 500 includes a processor 510 and a non-transitory computer-readable storage medium 520. The computer-readable storage medium 520 includes example instructions 521-523 executable by the processor 510 to perform various functionalities described herein. In various examples, the non-transitory computer-readable storage medium 520 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 510 may be a general purpose processor, special purpose logic, or the like.

The example instructions include receive a request from a user device instructions 521. As noted above, the request includes a 3D print data file and identification of a service associated with the 3D print data file. The example instructions further include identify a third party associated with the requested service 522. For example, as described above with reference to FIG. 2, the service platform 210 identifies one third party service provider from the set of third party service providers 240a-c based on capabilities associated with the requested service.

The example instructions further include provide a revised 3D print data file to the user device instructions 523. In this regard, the revised 3D print data file is the 3D print data file with the requested service performed thereon.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A device, comprising:
a user interface to receive a service request from a user device, the service request including a three-dimensional (3D) print data file and identification of a service associated with the 3D print data file;
a third party identification portion to identify a selected third party from a set of third parties, the selected third party having capabilities associated with the service;
a third-party interface to receive the service from the selected third party; and
a 3D print data file handling portion to replace the 3D print data file with a revised 3D print data file, the revised 3D print data file being the 3D print data file with the service performed.

2. The device of claim 1, further comprising a payment processing portion for processing a payment from the user device to the selected third party.

3. The device of claim 1, wherein the service associated with the 3D print data file is at least one of 3D object nesting, advanced packing, protective cage generation, minimizing of consumable, splitting of an oversized part into two or more parts, or forming a powder escape hole.

4. The device of claim 1, wherein the third party identification portion is to select a third party to minimize cost of service.

5. The device of claim 1, wherein the 3D print data file handling portion is to replace the 3D print data file with a revised 3D print data file by transmitting the 3D print data file to the selected third party and receiving the revised 3D print data file from the third party.

6. The device of claim 1, wherein the 3D print data file handling portion is to replace the 3D print data file with a revised 3D print data file by downloading software associated with the service from the third party and using the downloaded software to perform the service on the 3D print data file to generate the revised 3D print data file.

7. A system, comprising:
a user device coupled to a three-dimensional printer; and
a service platform to receive a service request from the user device, the service request including a three-dimensional (3D) print data file and a service to be performed on the 3D print data file;
wherein the service platform is:
to transmit the 3D print data file to a third-party service provider and to receive a revised 3D print data file from the third-party service provider, the third-party service provider having capabilities associated with the service to be performed, the revised 3D print data file being the 3D print data file with the service performed; or
to download the service from the third-party service provider and to generate the revised 3D print data file.

8. The system of claim 7, wherein the service platform is to management payment for the service from the user device to the third-party service provider.

9. The system of claim 7, wherein the service to be performed is at least one of 3D nesting, advanced packing, protective cage generation, minimizing of consumable or time to print, splitting of an oversized part into two or more parts, or forming a powder escape hole.

10. The system of claim 7, wherein the user device and the service platform are communicatively coupled through a public network.

11. The system of claim 7, wherein the service platform is to select a third-party service provider to minimize cost of service.

12. A non-transitory computer-readable storage medium encoded with instructions executable by a processor of a computing system, the computer-readable storage medium comprising instructions to:
receive a request from a user device, the request including a three-dimensional (3D) print data file and identification of a service associated with the 3D print data file;
identify a third party associated with the requested service; and
provide a revised 3D print data file to the user device, the revised 3D print data file being the 3D print data file with the service performed.

13. The non-transitory computer-readable storage medium of claim 12, further comprising instructions to:
process a payment from the user device to the third party for the service.

14. The non-transitory computer-readable storage medium of claim 12, wherein the instructions to provide a revised 3D print data file include instructions to:
transmit the 3D print data file to the selected third party; and
receive the revised 3D print data file from the third party.

15. The non-transitory computer-readable storage medium of claim 12, wherein the instructions to provide a revised 3D print data file include instructions to:
download software associated with the service from the third party; and
use the downloaded software to perform the service on the 3D print data file to generate the revised 3D print data file.
